(19) United States
(12) Patent Application Publication
(10) Pub. No.: US 2025/0211920 A1
(43) Pub. Date: Jun. 26, 2025

(54) METHOD FOR DETECTING A CONDITION OF A HEARING DEVICE

(71) Applicant: GN Hearing A/S, Ballerup (DK)

(72) Inventors: Facundo RAMÓN, Bagsværd (DK); Daniel Fernández ÁLVAREZ, Copenhagen (DK)

(73) Assignee: GN Hearing A/S, Ballerup (DK)

(21) Appl. No.: 18/983,024

(22) Filed: Dec. 16, 2024

(30) Foreign Application Priority Data
Dec. 22, 2023 (EP) 23219622.0

(51) Int. Cl. H04R 25/00; H04R 11/02

(52) U.S. Cl. CPC H04R 25/305; H04R 25/604; H04R 11/02; H04R 2225/023

(57) ABSTRACT

A hearing device includes: an electroacoustic transducer; a spout; and a controller configured to generate an electrical signal, estimate a first electrical voltage at a first frequency across input terminals of the transducer by applying the electrical signal, estimate a second electrical voltage at a second frequency, and determine a difference between the first electrical voltage and the second electrical voltage, the second frequency being higher than the first frequency; wherein the controller is configured to: determine a state of the hearing device as (1) having an open spout if the difference is below a first threshold value, (2) having a fully clogged spout if the difference is above a second threshold value, wherein the second threshold value is above the first threshold value, and (3) having a partially clogged spout if the difference is between the first threshold value and the second threshold value.

### RELATED APPLICATION DATA

This application claims priority to, and the benefit of, European Patent Application No. 23219622.0 filed on Dec. 22, 2023. The entire disclosure of the above application is expressly incorporated by reference herein.

### FIELD

The present disclosure relates to audio data processing, sometimes referred to as audio signal processing. More specifically, the disclosure relates to a computer-implemented method for detecting a condition of a hearing device, the hearing device and a system comprising the hearing device and an external device communicatively connected to the hearing device.

### BACKGROUND

During the last couple of years, the development of hearing devices have made significant progress. By way of example, by being able to reduce the size of components, it has been possible to provide ear-worn hearing devices that despite their small size can produce high quality listening experiences. For hearing aids, which are a type of hearing devices, this development has made it possible to provide receiver-in-the-ear (RIE) devices and behind-the-ear (BTE) devices that can be worn by users for longer periods of time without discomfort and without compromising on hearing assistance capability.

Even though using these types of hearing devices comes with several advantages, a problem of having these placed in part or in full within the ear canal is that earwax (cerumen) may clog the hearing devices. By way of example, a spout, sometimes referred to as a receiver outlet, is placed in an earplug or dome, or connected to a sound tube, providing a sound passage for sound waves from the receiver, may be clogged. As an effect of having the sound waves hindered, the sound waves cannot reach the user properly, which in turn results in reduced or no hearing assistance and/or a deteriorated listening experience.

Having spouts in hearing devices clogged with earwax is, however, not a new problem and different solutions have been presented. A common solution is to provide a so-called wax filter on the spout. By having this filter, sound waves are allowed to pass, but the earwax is hindered from entering into the spout and an interior of the hearing device. Once the filter is clogged, that is, once the amount of earwax present in the filter has reached a level such that this collected earwax is hindering the sound waves, the filter needs to be replaced. The operation of replacing the filter may be troublesome for some persons due to the small size of the filter. In some cases, for hearing aids, e.g. with small children or elderly people, it may also be difficult for the persons suffering from the reduced performance to inform persons that can help them about the reduced performance.

In addition to getting the filter clogged, there is also a risk that the filter comes off, which may not have an immediate effect, but may result in that the earwax enters into the hearing device and that this is clogged internally. Having the hearing device internally clogged often requires that the hearing device is opened up as part of the cleaning process. Such operation may require special tools and it is often recommended that such operation is performed by a trained technician to secure that the hearing device is not damaged during the cleaning operation.

A different approach to detecting presence of earwax in the spout is suggested in EP 2 039 216 A1. In this document, it is disclosed that an electrical impedance can be measured and that this may be subject to changes in case there is earwax present.

Even though there are solutions available today for both reducing the impact of the earwax for hearing devices and also methods for detecting the presence of earwax, there is nevertheless a need for methods and devices that more accurately and more reliably can detect the presence of earwax such that measures can be taken in a more timely manner.

### SUMMARY

It is an object to at least partly overcome one or more of the above-identified limitations of the prior art. In particular, it is an object to provide a method for making it possible to continuously and efficiently monitor the hearing device such that one or several conditions deteriorating performance of the hearing device can be detected. An example of such condition is that a spout of the receiver of the hearing device is partly or fully clogged by earwax.

According to a first aspect it is provided a computer-implemented method for detecting a condition of a hearing device. The hearing device may comprise an electroacoustic transducer having at least two input terminals, a spout connected to the transducer, and a controller. The method may comprise generating an electrical signal for reproduction by the transducer, estimating a first electrical voltage at a first frequency across the input terminals of the transducer by applying the electric signal to the transducer, estimating a second electrical voltage at a second frequency by applying the electrical signal, wherein the second frequency is higher than the first frequency, determining a difference between the first electrical voltage and the second electrical voltage by the controller, assigning a first state to the condition in case the difference is below a first threshold value, assigning a second state to the condition in case the difference is above a second threshold value, wherein the second threshold value is above the first threshold value, and assigning a third state to the condition in case the difference is between the first threshold value and the second threshold value.

By having the first and second frequency adapted to the transducer, it is made possible to detect at least three different states. By way of example, it can be detected that the spout is open, i.e. no clogging present, partially clogged or fully clogged. In this way, the performance of the hearing device can be monitored over time and actions required for overcoming unwanted conditions, such as a clogged spout, can be detected at an early stage.

The hearing device may be a receiver-in-ear (RIE) hearing device.

The first and second electrical voltage may reflect a first and a second electrical input impedance, respectively.

The electroacoustic transducer may be a balanced-armature transducer.

The frequencies may be audio frequencies, wherein the first frequency is below 2500 Hz and the second frequency is above 2500 Hz.

The first and second frequency may be chosen based on where the transducer has a pronounced electric input impedance resonance.

The electric signal may be a pre-set audio signal stored in a memory comprised in the hearing device.

The spout of the transducer may be provided with a filter to hinder earwax from transferring into the spout. The method may further comprise assigning a fourth state to the condition in case the difference is below a third threshold value, wherein the third threshold valve is below the first threshold value.

The hearing device may be arranged to communicate with an external device, such as a mobile phone. The method may further comprise transmitting an “open spout” notification signal from the hearing device to the external device if the first state is assigned to the condition, transmitting a “blocked spout” notification signal from the hearing device to the external device if the second state is assigned to the condition, transmitting a “partially blocked spout” notification signal from the hearing device to the external device if the third state is assigned to the condition, and/or transmitting a “missing filter” notification signal from the hearing device to the external device if the fourth state is assigned to the condition.

According to a second aspect it is provided a hearing device comprising an electroacoustic transducer having at least two input terminals, a spout connected to the transducer, and a controller. The controller may be configured to generate an electrical signal for reproduction by the transducer, estimate a first electrical voltage at a first frequency across the input terminals of the electroacoustic transducer in the hearing device by applying the electrical signal, estimate a second electrical voltage at a second frequency in the hearing device by applying the electrical signal across the input terminals of the electroacoustic transducer, wherein the second frequency is higher than the first frequency, determine a difference between the first electrical voltage and the second electrical voltage, assign a first state to the condition in case the difference is below a first threshold value, assign a second state to the condition in case the difference is above a second threshold value, wherein the second threshold value is above the first threshold value, and assign a third state to the condition in case the difference is between the first threshold value and the second threshold value.

The same features and advantages as presented above with respect to the first aspect also apply to this aspect.

The hearing device may be a receiver-in-ear (RIE) hearing device.

The electroacoustic transducer may be a balanced-armature transducer.

The electric signal may be a pre-set audio signal stored in a memory.

According to a third aspect it is provided a system comprising the hearing device according to second aspect and an external device, wherein the hearing device is arranged to communicate the state of the condition to the external device.

According to a fourth aspect it is provided a computer program product comprising instructions which, when executed by the controller, cause this to carry out the method according to the first aspect.

The hearing device can be a hearing aid, i.e. one or two devices configured for alleviating a hearing loss and worn by a user in one or two ears. As is commonly known, the hearing devices may be provided with one or several microphones, processors, and memories for processing the data received by the microphone(s), and one or several transducers provided for producing sound waves to the user of the hearing device. In case of having two hearing devices, these may be configured to communicate with each other such that the hearing experience could be improved. The hearing device may also be configured to communicate with an external device, such as a mobile phone, and the audio input data may in such case be captured by the mobile phone and transferred to the hearing device. The mobile phone may also in itself constitute the hearing device.

The term ‘hearing device’ should not be understood in this context as a device solely used by persons with hearing disabilities, but instead as a device used by anyone interested in perceiving speech more clearly, i.e. improving speech intelligibility. The hearing device may, when not being used for providing the audio output data, be used for music listening or similar. Put differently, the hearing device may be earbuds, a headset or other similar pieces of equipment that are configured so that when receiving the audio input data this can be transformed into the audio output data as described herein.

The hearing device may also form part of a device not solely used for listening purposes. For instance, the hearing device may be a pair of smart glasses. In addition to transforming the audio input data into the audio output data as described herein and providing the resulting sound via e.g. spectacles sidepieces of the smart glasses, these glasses may also present visual information to the user by using the lenses as a head up-display.

The hearing device may be configured to be worn by a user. The hearing device may be arranged at the user's ear, on the user's ear, over the user's ear, in the user's ear, in the user's ear canal, behind the user's ear and/or in the user's concha, i.e., the hearing device is configured to be worn in, on, over and/or at the user's ear. The user may wear two hearing devices, one hearing device at each ear. The two hearing devices may be connected, such as wirelessly connected and/or connected by wires, thus forming a binaural hearing aid system.

The hearing device may be a hearable such as a headset, headphone, earphone, earbud, hearing aid, a personal sound amplification product (PSAP), an over-the-counter (OTC) hearing device, a hearing protection device, a one-size-fits-all hearing device, a custom hearing device or another head-wearable hearing device. Hearing devices can include both prescription devices and non-prescription devices.

The hearing device may be embodied in various housing styles or form factors. Some of these form factors are earbuds, on-the-ear headphones, or over-the-ear headphones. The person skilled in the art is well aware of different kinds of hearing devices and of different options for arranging the hearing device in, on, over and/or at the ear of the hearing device wearer. The hearing device (or pair of hearing devices) may be custom fitted, standard fitted, open fitted and/or occlusive fitted.

The hearing device may comprise one or more input transducers. The one or more input transducers may comprise one or more microphones. The one or more input transducers may comprise one or more vibration sensors configured for detecting bone vibration. The one or more input transducer(s) may be configured for converting an acoustic signal into a first electric input signal. The first electric input signal may be an analogue signal. The first electric input signal may be a digital signal. The one or more input transducer(s) may be coupled to one or more analogue-to-digital converter(s) configured for converting the analogue first input signal into a digital first input signal.

The hearing device may comprise one or more antenna(s) configured for wireless communication. The one or more antenna(s) may comprise an electric antenna. The electric antenna may be configured for wireless communication at a first frequency. The first frequency may be above 800 MHZ, preferably a wavelength between 900 MHz and 6 GHZ. The first frequency may be 902 MHz to 928 MHz. The first frequency may be 2.4 to 2.5 GHZ. The first frequency may be 5.725 GHz to 5.875 GHz. The one or more antenna(s) may comprise a magnetic antenna. The magnetic antenna may comprise a magnetic core. The magnetic antenna may comprise a coil. The coil may be coiled around the magnetic core. The magnetic antenna may be configured for wireless communication at a second frequency. The second frequency may be below 100 MHz. The second frequency may be between 9 MHz and 15 MHz.

The hearing device may comprise one or more wireless communication unit(s). The one or more wireless communication unit(s) may comprise one or more wireless receiver(s), one or more wireless transmitter(s), one or more transmitter-receiver pair(s) and/or one or more transceiver(s). At least one of the one or more wireless communication unit(s) may be coupled to the one or more antenna(s). The wireless communication unit may be configured for converting a wireless signal received by at least one of the one or more antenna(s) into a second electric input signal. The hearing device may be configured for wired/wireless audio communication, e.g., enabling the user to listen to media, such as music or radio and/or enabling the user to perform phone calls.

The wireless signal may originate from one or more external source(s) and/or external devices, such as spouse microphone device(s), wireless audio transmitter(s), smart computer(s) and/or distributed microphone array(s) associated with a wireless transmitter. The wireless input signal(s) may originate from another hearing device, e.g., as part of a binaural hearing system and/or from one or more accessory device(s), such as a smartphone and/or a smart watch.

The hearing device may include a processing unit. The processing unit may be configured for processing the first and/or second electric input signal(s). The processing may comprise compensating for a hearing loss of the user, i.e., apply frequency dependent gain to input signals in accordance with the user's frequency dependent hearing impairment. The processing may comprise performing feedback cancelation, beamforming, tinnitus reduction/masking, noise reduction, noise cancellation, speech recognition, bass adjustment, treble adjustment and/or processing of user input. The processing unit may be a processor, an integrated circuit, an application, functional module, etc. The processing unit may be implemented in a signal-processing chip or a printed circuit board (PCB). The processing unit may be configured to provide a first electric output signal based on the processing of the first and/or second electric input signal(s). The processing unit may be configured to provide a second electric output signal. The second electric output signal may be based on the processing of the first and/or second electric input signal(s).

The hearing device may comprise an output transducer. The output transducer, herein also referred to as electroacoustic transducer or receiver, may be coupled to the processing unit. The output transducer may be a loudspeaker. The output transducer may be configured for converting the first electric output signal into an acoustic output signal. The output transducer may be coupled to the processing unit via the magnetic antenna.

In an embodiment, the wireless communication unit may be configured for converting the second electric output signal into a wireless output signal. The wireless output signal may comprise synchronization data. The wireless communication unit may be configured for transmitting the wireless output signal via at least one of the one or more antennas.

The hearing device may comprise a digital-to-analogue converter configured to convert the first electric output signal, the second electric output signal and/or the wireless output signal into an analogue signal.

The hearing device may comprise a vent. A vent is a physical passageway such as a canal or tube primarily placed to offer pressure equalization across a housing placed in the ear such as an ITE hearing device, an ITE unit of a BTE hearing device, a CIC hearing device, a RIE hearing device, a RIC hearing device, a MaRIE hearing device or a dome tip/earmold. The vent may be a pressure vent with a small cross section area, which is preferably acoustically sealed. The vent may be an acoustic vent configured for occlusion cancellation. The vent may be an active vent enabling opening or closing of the vent during use of the hearing device. The active vent may comprise a valve.

The hearing device may comprise a power source. The power source may comprise a battery providing a first voltage. The battery may be a rechargeable battery. The battery may be a replaceable battery. The power source may comprise a power management unit. The power management unit may be configured to convert the first voltage into a second voltage. The power source may comprise a charging coil. The charging coil may be provided by the magnetic antenna.

The hearing device may comprise a memory, including volatile and non-volatile forms of memory.

The hearing device may comprise one or more antennas for radio frequency communication. The one or more antennae may be configured for operation in ISM frequency band. One of the one or more antennas may be an electric antenna. One or the one or more antennas may be a magnetic induction coil antenna. Magnetic induction, or near-field magnetic induction (NFMI), typically provides communication, including transmission of voice, audio, and data, in a range of frequencies between 2 MHz and 15 MHz. At these frequencies the electromagnetic radiation propagates through and around the human head and body without significant losses in the tissue.

The magnetic induction coil may be configured to operate at a frequency below 100 MHz, such as at below 30 MHZ, such as below 15 MHZ, during use. The magnetic induction coil may be configured to operate at a frequency range between 1 MHz and 100 MHz, such as between 1 MHz and 15 MHz, such as between 1 MHz and 30 MHz, such as between 5 MHz and 30 MHz, such as between 5 MHz and 15 MHz, such as between 10 MHz and 11 MHz, such as between 10.2 MHz and 11 MHz. The frequency may further include a range from 2 MHz to 30 MHz, such as from 2 MHz to 10 MHz, such as from 2 MHz to 10 MHZ, such as from 5 MHz to 10 MHz, such as from 5 MHz to 7 MHz.

The electric antenna may be configured for operation at a frequency of at least 400 MHZ, such as of at least 800 MHZ, such as of at least 1 GHZ, such as at a frequency between 1.5 GHZ and 6 GHZ, such as at a frequency between 1.5 GHZ and 3 GHz such as at a frequency of 2.4 GHz. The antenna may be optimized for operation at a frequency of between 400 MHz and 6 GHZ, such as between 400 MHz and 1 GHZ, between 800 MHz and 1 GHz, between 800 MHz and 6 GHZ, between 800 MHz and 3 GHZ, etc. Thus, the electric antenna may be configured for operation in ISM frequency band. The electric antenna may be any antenna capable of operating at these frequencies, and the electric antenna may be a resonant antenna, such as monopole antenna, such as a dipole antenna, etc. The resonant antenna may have a length of λ/4±10% or any multiple thereof, λ being the wavelength corresponding to the emitted electromagnetic field.

The present disclosure relates to different aspects including the hearing device and the system described above and in the following, and corresponding device parts, each yielding one or more of the benefits and advantages described in connection with the first mentioned aspect, and each having one or more embodiments corresponding to the embodiments described in connection with the first mentioned aspect and/or disclosed in the appended claims.

### BRIEF DESCRIPTION OF DRAWINGS

The above and other features and advantages will become readily apparent to those skilled in the art by the following detailed description of exemplary embodiments thereof with reference to the attached drawings, in which:

FIG. 1 is a diagram illustrating electric input impedance measurement at two input terminals of the transducer as a function of frequency for different clogging levels.

FIG. 2 is a diagram illustrating an impedance difference for two frequencies as a function of clogging level.

FIG. 3A is a diagram illustrating a white noise test signal that can be used for determining the two frequencies.

FIG. 3B is a diagram illustrating a measured input impedance as a function of frequency, caused by the test signal illustrated in FIG. 3A, for a hearing device with an open spout.

FIG. 3C is a diagram illustrating a measured input impedance as a function of frequency, caused by the test signal illustrated in FIG. 3A, for a hearing device with a partially clogged spout.

FIG. 3D is a diagram illustrating a measured input impedance as a function of frequency, caused by the test signal illustrated in FIG. 3A, for a hearing device with a clogged spout.

FIG. 4A illustrates, in an upper part, a test signal comprising two sine waves with different frequencies, and, in a lower part, Root Mean Square (RMS) voltage values measured at the input terminals for the two sine waves for a hearing device with the spout open.

FIG. 4B illustrates in an upper part a test signal comprising two sine waves with different frequencies, and in a lower part, RMS voltage values measured at the input terminals with the spout clogged is illustrated.

FIG. 5 is a diagram illustrating difference in impedance for two selected frequencies as a function of clogging level.

FIG. 6 is a flow chart illustrating a method for determining a spout condition of the hearing device.

FIG. 7 is a schematic illustration of a hearing device.

### DETAILED DESCRIPTION

Various embodiments are described hereinafter with reference to the figures. Like reference numerals refer to like elements throughout. Like elements will, thus, not be described in detail with respect to the description of each figure. It should also be noted that the figures are only intended to facilitate the description of the embodiments. They are not intended as an exhaustive description of the claimed invention or as a limitation on the scope of the claimed invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

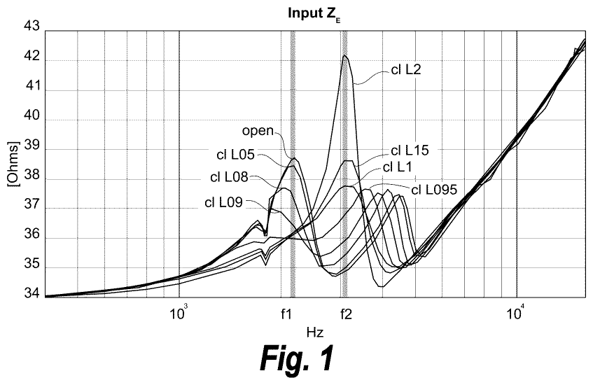

FIG. 1 is a diagram illustrating an electrical input impedance (Input Z_{E}), measured in Ω (Ohm), as a function of frequency, measured in Hz, for seven different clogging levels of a spout of a hearing device, i.e., a sound outlet of an electroacoustic transducer, also referred to as receiver or speaker, conducting sound to an outside of the hearing device. The input impedance is the measured electric input impedance of the transducer of the hearing device, more particularly the electric input impedance measured between two input terminals. The underlying effect causing the input impedance to react differently to different clogging levels is that the clogging gives rise to acoustic and mechanical loads that are transferred to the electric domain via an electromagnetic circuit formed by the hearing device. The different clogging levels represented in the diagram are the following:
open: No cerumen
cl L05: 50% clogged
cl L08: 80% clogged
cl L09: 90% clogged
cl L095 95% clogged
cl L1: 100% clogged
cl L15: 150% clogged
cl L2: 200% clogged

The two latter cases represent a spout that is fully blocked and on top of this, another layer of earwax is added that is providing an extra 50% blockage and an extra 100% blockage, respectively.

As can be seen from the diagram illustrated in FIG. 1, there is a relationship between the input impedance (Input Z_{E}) and the clogging level. The input impedance also depends on the frequency. Put differently, for different clogging levels, the measured input impedance depends in different ways on the frequency. As will be further elaborated on below, by making use of these relationships it is made possible to detect clogging and other unwanted conditions of the hearing device efficiently by measuring the input impedance, or measuring a proportional property, such as a voltage, and processing these measurements.

As illustrated in FIG. 1, different clogging levels are not giving rise to the input impedance in the same way over the full frequency spectrum. In this example, up until 1000 Hz, the different clogging levels are all giving rise to more or less the same input impedance. The same holds true for frequencies above about 6000 Hz. In a frequency range between this lower and upper frequency limit, different clogging levels are giving rise to different input impedances. As an effect, by measuring a first input impedance at a first frequency f1, herein exemplified by 2180 Hz, and a second input impedance at a second frequency f2, herein exemplified by 3160 Hz, it is made possible to determine, or at least estimate, the clogging level based on the first and second input impedance.

By way of example, in case the first input impedance is about 4 Ohms higher than the second input impedance, there is an indication that the clogging level is open (open), that is, no cerumen present. In this example, in case the clogging level is at 50% (cl L05), the second input impedance is also higher than the first input impedance, even though to a lesser extent. For the clogging level at 80% (cl L08), the first input impedance is also greater than the second input impedance, but to an even lesser extent, about 2 Ohms in difference. For the clogging level at 90% (cl L09) the first input impedance is also greater than the second input impedance, but only to a minor extent, and the two input impedances are almost the same.

For the clogging level at 95% (cl L095), there is a change and instead of the first input impedance being greater than the second input impedance, as is the case for clogging levels open, cl L05, cl L08 and cl L09, the second input impedance is now greater than the first input impedance. The same holds true for the clogging level at 100% (cl L1), the clogging level at 150% (cl L15) and the clogging level at 200% (cl L2). As illustrated, the more clogging, the greater difference between the second and first input impedance.

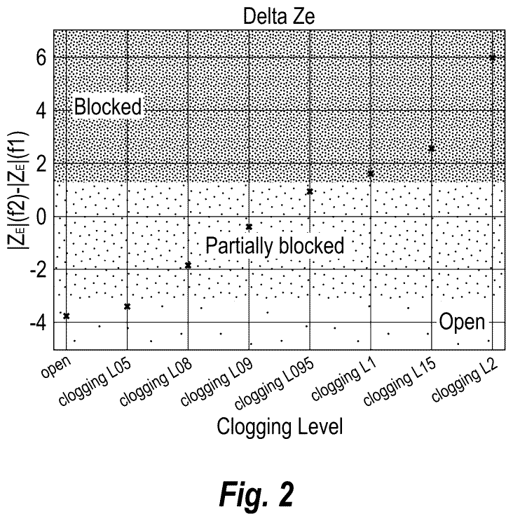

In FIG. 2, a difference between an absolute value of the input impedance at the second frequency f2 and an absolute value of the input impedance at the first frequency f1 is plotted with respect to the clogging levels. In line with FIG. 1, in the diagram of FIG. 2, it can be seen that by using the input impedance at two selected frequencies, it is made possible to determine the clogging level of the hearing device. Since the difference illustrated in FIG. 2 is increasing as a function of the clogging level, the difference is likely to evolve over time (since earwax clogging typically increases over time, and generally does not decrease without any active measures taken). Thus, by measuring this difference over time, a more reliable clogging detection can be achieved. An advantage of this approach is that an early indication could be transmitted from the hearing device to a mobile phone, or other devices connected to the hearing device, already when the hearing device is found to be partially blocked, such that the earwax removal or a wax filter exchange may be performed before the performance of the hearing device is significantly reduced.

As mentioned briefly in the foregoing, it is advantageous for practical reasons to measure a property proportional to the impedance Z_{E}, such as a voltage, instead of the impedance Z_{E} itself. Consider an output resistance R_{g} of a generator connected to a receiver. The resistance R_{g} is preferably very small, but not zero. Together with the impedance Z_{E} of the receiver, the resistance R_{g} forms a voltage divider thus:

$${V}_{spk} = \frac{{Z}_{E}}{{R}_{g} + {Z}_{E}} \cdot {V}_{g} ⇒ {Z}_{E} ∝ \frac{{V}_{p k}}{{V}_{g}} ,$$

where Vₛₚₖ is the voltage measured across the receiver and V_{g} is the measured generator voltage. In other words, Z_{E} is proportional to Vₛₚₖ/V_{g}. This proportionality is sufficient for the purpose of determining a change in the impedance Z_{E}. When V_{g} is constant, Vₛₚₖ will thus change with any change in the impedance Z_{E}, and this voltage may be measured in a simple and convenient way as will be shown in the following.

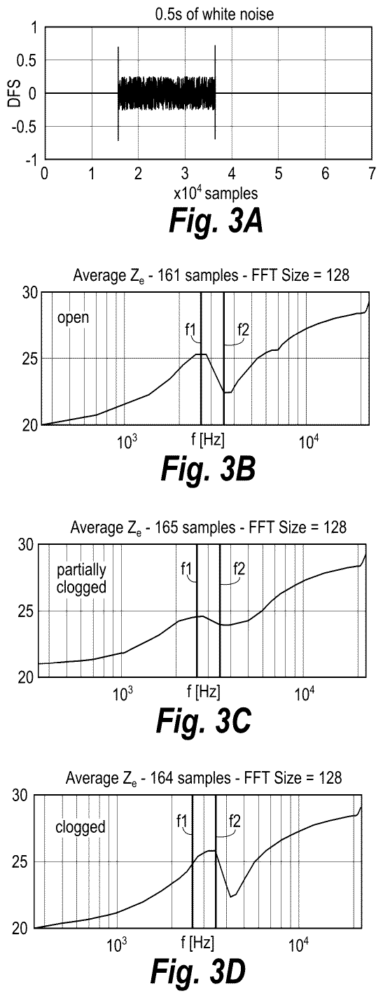

There are different ways of reducing the principle presented above into practice. One way is to use white noise, that is, a signal having equal intensity across different frequencies. As illustrated in FIG. 3A, the signal may be a 0.5 second burst of white noise. In the example illustrated, a period of 70 kilosamples is shown, equal to 1.6 seconds at a sample rate of 44.1 KHz. At approximately 16 kilosamples, the noise burst starts and at about 38 kilosamples the noise burst stops again. The average amplitude of the noise burst is ±0.2 of a signed, digital full-scale level from −1 to +1, the noise burst thus lasting for 20608 samples total.

Continuing the example, based on the signal illustrated in FIG. 3A, in FIG. 3B it is illustrated an average input impedance measurement of the receiver with an open spout. The input impedance is measured in the frequency domain between 300 Hz and 20 KHz. The measurement is performed by a 128-point Fast-Fourier Transform (FFT) transform averaging over a 0.47 second of the signal, resulting in 161 samples (20608/128). In line with FIG. 1, for the particular receiver tested, a local maximum is found where the first frequency f1 is 2180 Hz and a local minimum is found where the second frequency f2 is 3160 Hz. For other receivers, the frequencies f1 and f2 may be different, as long as f2>f1. The first electric input impedance measured is, in this example, 25.5Ω, and the second electric input impedance is 22.5Ω. Since the first input impedance is greater than the second input impedance, it can be concluded that the spout is open, i.e., no clogging is present.

As illustrated in FIG. 3C, if using the signal illustrated in FIG. 3A as input when the spout of the hearing device is partially clogged, a measurement carried out in the same manner as described with reference to FIG. 3B shows that the input impedance at the first frequency f1 and the second frequency f2 is 24.5Ω and 24.0Ω, respectively. In other words, in line with FIG. 2, when the first and second input impedance is about the same, this may be an indication that the spout is partially clogged.

Further, when the spout is fully clogged, as illustrated in FIG. 3D, the second input impedance is greater than the first input impedance. In this particular example, a similar measurement shows that the input impedance at the first frequency f1 is 25.0Ω and the input impedance at the second frequency f2 is 26.0Ω.

Using white noise as described above for detecting a condition of the hearing device can also be used for determining appropriate selections of the first and second frequencies, f1 and f2, respectively, for a particular receiver type. Put differently, this white noise approach can be used as part of the set-up process, also referred to as configuration, of the hearing device. Different receiver types may namely reflect the input impedance as a function of frequency differently. One reason for using the white noise approach during the set-up and not during operation, i.e. in the hearing device in use, is that FFT operations come with a computational cost necessitating the use of more expensive components in the hearing device as well as an increase in the power requirements of the hearing device, thus reducing battery life, making it necessary to e.g., charge the battery more often in case of a rechargeable battery being used.

Instead of using the white noise as the input signal, as suggested, and described above with reference to FIG. 3A to 3D, the input signal, also herein referred to as a test signal, may be two tones played after one another. The two tones may have the first and second frequency f1, f2, respectively, and they may have a duration of 0.1 second each.

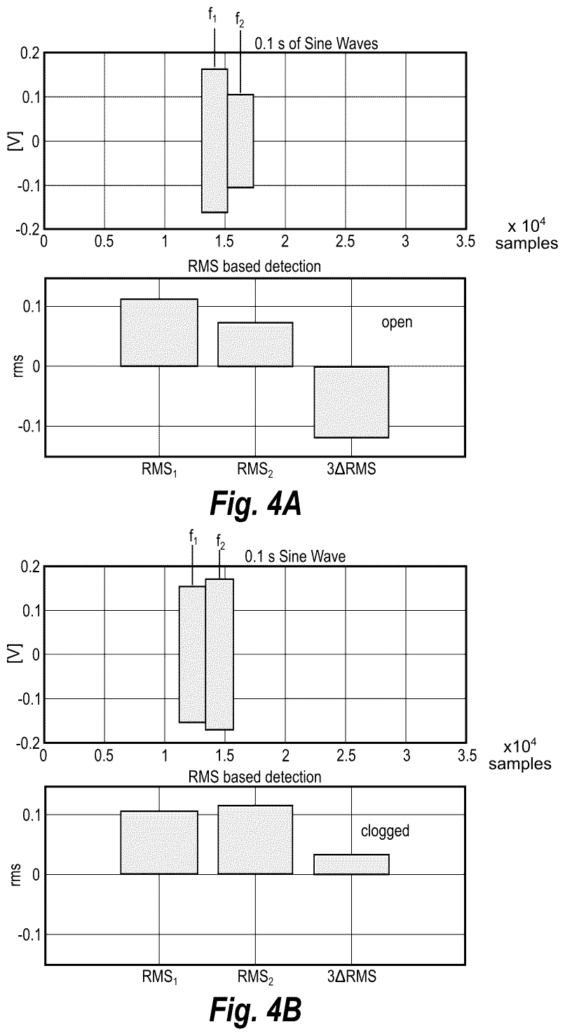

FIG. 4A illustrates, in an upper part, an example in which the two tones are presented during a test signal being monitored over approximately 35 kilosamples at 44.1 KHz, i.e., for a period of approximately 0.8 seconds. On a y-axis, a value representing a voltage measured at two speaker terminals of the hearing device is presented. In a lower part of FIG. 4A, a Root Mean Square (RMS) voltage value measured on the input to the receiver for the first tone using the first frequency f1, referred to as RMS₁, as well as the RMS voltage value measured for the second tone using the second frequency f2, referred to as RMS₂, is illustrated. In addition, a difference between the two are depicted, tripled for clarity, and thus denoted 3ΔRMS. Since the tripled difference 3ΔRMS is negative, that is, RMS₁ is greater than RMS₂, it can be concluded that there is no clogging, that is, the spout is open.

FIG. 4B illustrates another example with the same two tones. In an upper part of FIG. 4, two tones are presented during a test signal being monitored over approximately 35 kilosamples, similar to the test signal illustrated in FIG. 4A. As illustrated, in this example, the tones give rise to different voltages across the speaker terminals. The second frequency f2 gives rise to a higher voltage compared to the similar measurement of the example illustrated in FIG. 4A. Since it has been found that the value representing the voltage measurements at the terminals will be different for different conditions of the hearing device, conclusions about the condition of the hearing device can be made by measuring the voltage across the speaker terminals at the selected frequencies f1 and f2. As shown in the foregoing, the voltage measured across the speaker terminals is directly proportional to the input impedance. Since the impedance is an indication of the condition of the hearing device, a computationally efficient way of monitoring the condition is therefore to measure the voltage across the terminals at the selected frequencies, that is, frequencies in which the device has a local maximum or minimum visible in the electric impedance.

An advantage of using the approach suggested above and illustrated in FIGS. 4A and 4B is that no FFT calculations are needed. The frequencies f1 and f2 may be pre-calculated and stored in a memory of the hearing device. Since the frequencies f1 and f2 are specific to the receiver model, the storage of the frequency values may be made when selecting e.g., a specific receiver for a particular hearing device. One way of calculating these frequencies is to use the approach presented above and illustrated in FIG. 3A-3D. By avoiding FFT calculations in the hearing device itself, less computational power is needed during use, i.e., during operation of the hearing device for detecting unwanted conditions, such as clogging of the receiver spout, that affect the impedance.

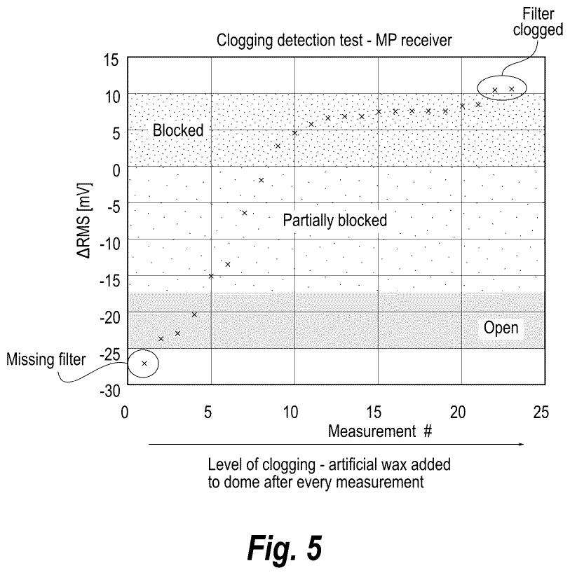

FIG. 5 is a diagram illustrating the difference in RMS, ΔRMS, as a function of clogging level. In the example illustrated, additional, artificial wax was added after each measurement.

As illustrated, just as it is possible to detect level of clogging using an impedance difference calculated based on the input impedance for the two frequencies f1 and f2, it is possible to determine the clogging level by using a voltage difference calculated based on the voltage measurement across the two speaker terminals at the two frequencies f1 and f2. As illustrated, in addition to determining the level of clogging of the spout, by using this approach it is also possible to detect e.g., that the wax filter is missing, that is, the tiny device mounted to the spout to prevent earwax from entering into the hearing device. In addition, it is also possible to detect that the wax filter is clogged.

Even though not illustrated, this principle of detecting unwanted conditions of the hearing device by measuring the voltage across the receiver terminals exploiting the fact that the voltage is proportional to the impedance for two or more selected frequencies can also be used for detecting e.g., a leaky coupling.

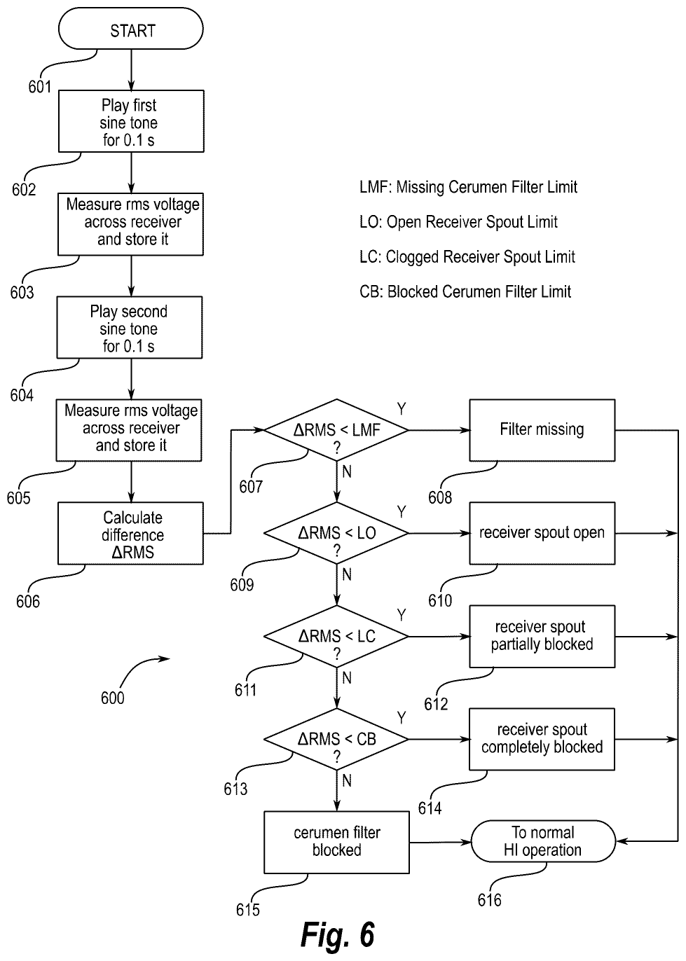

FIG. 6 is a flowchart illustrating a method 600 for monitoring a spout condition of the hearing device by way of example, also referred to as a receiver clogging test routine. The test routine may beneficially be carried out every time the hearing device is turned on, prior to assuming normal hearing device operation. After start 601, a first sine tone is played 602 for 0.1 seconds. The first tone may be generated by an internal generator. In line with the example above, the first sine tone may have a first frequency f1 as discussed in the foregoing. Next, the voltage is measured across the two speaker terminals, and the measured RMS voltage is stored 603 in a memory. Thereafter, a second tone is played 604 for 0.1 second. The tone may have a second frequency f2 and may also be generated by the internal generator. The voltage across the speaker terminals induced by the second tone is measured across the terminals and the measured RMS voltage is stored 605 in memory. Based on the two RMS voltage values associated with the first and second tone, respectively, a difference ΔRMS is calculated 606.

In case the difference is below a Missing Cerumen (earwax) Filter limit LMF 607, a state of the hearing device is set to filter missing 608. In case this state is entered, this may in turn trigger that an indication is sent to a mobile phone or other device linked to the hearing device. In the example in FIG. 5, the LMF limit may be −25 mV.

In case the difference is below an Open Receiver Spout limit LO 609 (and above the LMF limit), the state of the hearing device may be set to receiver spout open 610. The LO limit may be −17 mV in the example in FIG. 5.

In case the difference is below a Clogged Receiver Spout limit LC 611 (and above the LO limit), the state of the hearing device may be set to receiver spout partially blocked 612. The LC limit may be 0 mV in the example in FIG. 5.

In case the difference is below a Cerumen Filter Blocked limit 613 (and above the LC limit), the state of the hearing device may be set to receiver spout completely blocked 614.

Finally, in case the difference is above the Cerumen Filter Blocked limit CB, the state of the hearing device may be set to cerumen filter blocked 615. In the example in FIG. 5, the CB limit may be +10 mV.

When the state of the hearing device has been determined by testing the measured ΔRMS against the various limits provided in the structure, the current state is communicated to a suitable interface in the hearing device, whereafter the hearing device assumes normal operation in the exit step To normal HI (hearing instrument) operation 616. The possible states of the hearing aid, i.e., filter missing, receiver spout open, receiver spout partially blocked, receiver spout completely blocked, and cerumen filter blocked, resulting from the measurement, may beneficially alert a user of the hearing device if the receiver of the hearing device is open, blocked, has a missing wax filter, or if the wax filter needs to be exchanged.

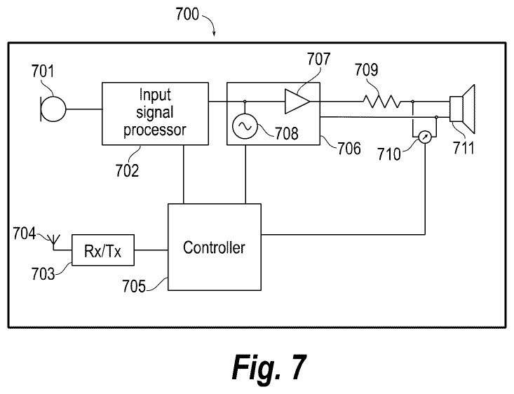

FIG. 7 generally illustrates a hearing device 700 by way of example. As illustrated, sound waves may be captured by a microphone 701. Even though a single microphone is illustrated, several microphones may be available. Further, the microphone(s) may, in addition to capture sound that is to be presented to a user of the hearing device, also be arranged to capture sound that is to be used, e.g., for compensating noise present in a surrounding environment. The microphone 701 may be communicatively connected to an input signal processor 702.

A transceiver module 703 provided with an antenna 704 is provided for receiving data wirelessly from e.g., another hearing device and/or from an external device, such as a mobile phone. The transceiver module 703 and the input signal processor 702 may be connected to a controller 705 configured for controlling signals captured via the microphone 701 and processed by input signal processor 702 as well as signals received via the antenna 704. Processed audio data can be transferred from the input signal processor 702 to an output module 706 comprising an output amplifier 707 and an oscillator 708. As illustrated, the input signal processor 702 is arranged to transfer audio data directly to the output amplifier 707. Via an internal resistance 709, signals, sometimes referred to as data, can be transferred from the output amplifier 707 to a receiver 711, also herein referred to as electroacoustic transducer, transducer, or speaker. As illustrated, between the two input terminals of the receiver 711, a voltage measurement device 710 is arranged. By using the voltage measurement device 710, it is made possible to measure the RMS voltage across the terminals of the receiver 711 that may be used for determining a condition of the hearing device as described above. The voltage measurement device 710 may be connected to the controller 705 such that the measurements made can be processed for the purpose of determining, or at least estimating the condition of the hearing device. Even though not illustrated, a receiver spout may connect the receiver 711 to an outside of the hearing device 700.

In this way, the current condition of a hearing device receiver spout may be monitored and conveyed to a user of the hearing device in a fast, safe, and reliable way.

Although particular features have been shown and described, it will be understood that they are not intended to limit the claimed invention, and it will be made obvious to those skilled in the art that various changes and modifications may be made without departing from the scope of the claimed invention. The specification and drawings are, accordingly, to be regarded in an illustrative rather than restrictive sense. The claimed invention is intended to cover all alternatives, modifications, and equivalents.

### LIST OF REFERENCES

600—method for monitoring spout condition/receiver clogging test routine
601—start
602—play first sine tone
603—measure RMS₁
604—play second sine tone
605—measure RMS₂
606—calculate ΔRMS
607—ΔRMS<LMF?
608—filter missing
609—ΔRMS<LO?
610—receiver spout open
611—ΔRMS<LC?
612—receiver spout partially blocked
613—ΔRMS<CB?
614—receiver spout completely blocked
615—cerumen filter blocked
616—to normal HI operation
700—hearing device
701—microphone
702—input signal processor
703—transceiver module
704—antenna
705—controller
706—output module
707—output amplifier
708—oscillator
709—internal resistance
710—voltage measurement device
711—receiver/electroacoustic transducer/speaker

1. A hearing device comprising:
an electroacoustic transducer having input terminals;
a spout associated with the electroacoustic transducer; and
a controller configured to generate an electrical signal, estimate a first electrical voltage at a first frequency across the input terminals of the electroacoustic transducer by applying the electrical signal, estimate a second electrical voltage at a second frequency, and determine a difference between the first electrical voltage and the second electrical voltage, wherein the second frequency is higher than the first frequency;
wherein the controller is configured to:
determine a state of the hearing device as having an open spout if the difference is below a first threshold value,
determine the state of the hearing device as having a fully clogged spout if the difference is above a second threshold value, wherein the second threshold value is above the first threshold value, and
determine the state of the hearing device as having a partially clogged spout if the difference is between the first threshold value and the second threshold value.

2. The hearing device according to claim 1, wherein the hearing device is a receiver-in-ear (RIE) hearing device.

3. The hearing device according to claim 1, wherein the electroacoustic transducer is a balanced-armature transducer.

4. The hearing device according to claim 1, wherein the electrical signal based on a pre-set audio data stored in a memory.

5. The hearing device according to claim 1, wherein the spout is coupled with the electroacoustic transducer.

6. The hearing device according to claim 1, wherein the first and second electrical voltages reflect a first electrical input impedance and a second electrical input impedance, respectively.

7. The hearing device according to claim 1, wherein the first frequency is below 2500 Hz, and the second frequency is above 2500 Hz.

8. The hearing device according to claim 1, wherein the first frequency and second frequency are based on where the electroacoustic transducer has a pronounced electric input impedance resonance.

9. The hearing device according to claim 1, further comprising a filter associated with the spout.

10. The hearing device according to claim 9, wherein the controller is configured to determine the state of the hearing device as having a missing filter if the difference is below a third threshold value, wherein the third threshold value is below the first threshold value.

11. A system comprising the hearing device according to claim 1 and an external device, wherein the hearing device is configured to communicate the state of the hearing device to the external device.

12. A method performed by a hearing device to determine a state of the hearing device, the hearing device comprising an electroacoustic transducer having input terminals, a spout associated with the transducer, and a controller, the method comprising:
generating an electrical signal;
estimating a first electrical voltage at a first frequency across the input terminals of the transducer by applying the electrical signal;
estimating a second electrical voltage at a second frequency, wherein the second frequency is higher than the first frequency;
determining, by the controller, a difference between the first electrical voltage and the second electrical voltage;
determining the state of the hearing device as having an open spout if the difference is below a first threshold value;
determining the state of the hearing device as having a blocked spout if the difference is above a second threshold value, wherein the second threshold value is above the first threshold value; and
determining the state of the hearing device as having a partially blocked spout if the difference is between the first threshold value and the second threshold value.

13. The method according to claim 12, wherein the hearing device is a receiver-in-ear (RIE) hearing device.

14. The method according to claim 12, wherein the first and second electrical voltages reflect a first electrical input impedance and a second electrical input impedance, respectively.

15. The method according to claim 12, wherein the electroacoustic transducer is a balanced-armature transducer.

16. The method according to claim 12, wherein the first frequency is below 2500 Hz, and the second frequency is above 2500 Hz.

17. The method according to claim 12, wherein the first frequency and second frequency are based on where the electroacoustic transducer has a pronounced electric input impedance resonance.

18. The method according to claim 12, wherein the electrical signal is based on a pre-set audio data stored in a memory of the hearing device.

19. The method according to claim 12, wherein the hearing device comprises a filter associated with the spout.

20. The method according to claim 19, further comprising determining the state of the hearing device as having a missing filter if the difference is below a third threshold value, wherein the third threshold value is below the first threshold value.

21. A processor-readable program product comprising instructions which, when executed, will cause the method of claim 12 to be performed.
